(19) United States
(12) Patent Application Publication
(10) Pub. No.: US 2007/0021981 A1
(43) Pub. Date: Jan. 25, 2007

(54) System for managing emergency personnel and their information

(76) Inventor: James Cox, Franklin, TN (US)

Correspondence Address: ERIC ROBINSON, PMB 955, 21010 SOUTHBANK ST., POTOMAC FALLS, VA, 20165, US

(21) Appl. No.: 11/473,041

(22) Filed: Jun. 23, 2006

Related U.S. Application Data
(60) Provisional application No. 60/694,694, filed on Jun. 29, 2005.

(51) Int. Cl. G06Q 10/00

(52) U.S. Cl. 705/2

(57) ABSTRACT

A system and method to request, coordinate, credential and manage medical personnel and their information to support disasters or emergencies, having a system to manage medical personnel credentialing information; a system to automatically contact medical personnel; a system for automatically verifying medical personnel credentialing and privileging information; and a system for the authentication of medical personnel.

### BACKGROUND OF THE INVENTION

Shortly after the September 11^{th} disaster, physicians, nurses and other health professionals flocked to the scene to offer help. Although they were greatly appreciated, their presence in the crisis raised important issues, for example; what can a hospital allow this newly arrived physician to do? If he does anything wrong, who is liable? How does the hospital know if a physician is who he says he is?

Recognizing these and other issues, the Department of Homeland Security has reached out to the healthcare community in an effort to establish a system that could facilitate marshaling and identifying medical personnel in case of a disaster. Congress further supported this idea and as a result “Public Law 107-188, Public Health Security and Bioterrorism Preparedness and Response Act of 2002,” was enacted. Initial meetings between government and industry leaders have produced a few guidelines and recommendations but to date no one has developed a comprehensive system or process that could technically encompass these guidelines, be easily deployable and economical to maintain.

The purpose of this invention is to provide a system and methodology to facilitate the marshaling, identification and communications between disaster management and the healthcare workers on a local, state or national level.

### BRIEF SUMMARY OF THE INVENTION

The present invention is directed to a system to request, coordinate, credential and manage medical personnel and their information to support disasters or emergencies.

The present invention is directed to a system to manage medical personnel credentialing information using standard interchange formats or sub-sets of standard interchange formats.

The present invention is directed to a system to manage medical personnel credentialing information that allows for mass updates using simple text files, spreadsheets or XML documents with or without the use of web services.

The present invention is directed to a system to manage medical personnel information that can be easily exchange data between individuals, hospitals and local, state and federal agencies using a common EDI or XML standard or a subset of those standards.

The present invention is directed to a system to manage medical personnel information that can be searched by user type, geographic location, medical specialty, training or other discriminator.

The present invention is directed to a system to manage medical personnel information that recognizes users by Personal Identification Numbers, biometric identification, face recognition or through the use of external security processing mechanisms.

The present invention is directed to a system to automatically contact medical personnel via phone, cellular phone, fax, email, internet or other messaging formats for the purpose of securing assistance during a disaster.

The present invention is directed to a system to provide a means for requested medical assistance personnel to respond to the request in either a positive or a negative fashion.

The present invention is directed to a system to provide a means for informing users and system managers of medical personnel response to requests.

The present invention is directed to a system to provide a means for automatically verifying medical personnel credentialing and privileging information via an internet search interface and or capture interface.

The present invention is directed to a system to provide a means for the authentication of medical personnel through the generation of unique alpha, numeric or alphanumeric codes.

The present invention is directed to a system to provide a means for automatic communications with disaster personnel via phone, cellular phone, radio, satellite or the internet for the purpose of requesting medical personnel assistance.

The present invention is directed to a system to provide a means for the storage, processing, management and dissemination of medical personnel information that is fully redundant in case of disaster.

The present invention is directed to a system to provide medical personnel information during a disaster via secure communications network using encryption or scrambling technology.

The present invention is directed to a system to provide a means for the storage, processing, management and dissemination of emergency medical personnel information that supports many levels and types of users.

The present invention is directed to a system to provide a means for the storage, processing, management and dissemination of medical personnel information that supports a separate command and control structure.

The present invention is directed to a system to provide a means for the storage, processing and dissemination of medical personnel information during a disaster that could be activated via single words or short phrases.

The present invention is directed to a system to provide a means for the storage, processing, management and dissemination of medical personnel information that could be used by on scene rescue personnel and which can be accessed via the internet or through other communications channels through the use of interactive voice recognition systems.

The present invention is directed to a system to provide for the tracking of medical personnel through the use of the Global Positioning System capability in cell phones and other portable devices.

The present invention is directed to a system for the graphical or numerical display of summoned emergency medical personnel using Global Positioning System information.

### BRIEF DESCRIPTION OF THE SEVERAL VIEWS OF THE DRAWINGS

The present invention will be described by way of exemplary embodiments, but not limitations, illustrated in the accompanying drawings in which like references denote similar elements, and in which:

FIG. 1 is a basic system flow block diagram illustrating one embodiment of the present invention.

FIG. 2 is a diagram of illustrating a healthcare worker data collection and maintenance system of one embodiment of the present invention.

FIG. 3 is a diagram illustrating an example of a node layout for system redundancy for one embodiment of the present invention of one embodiment of the present invention.

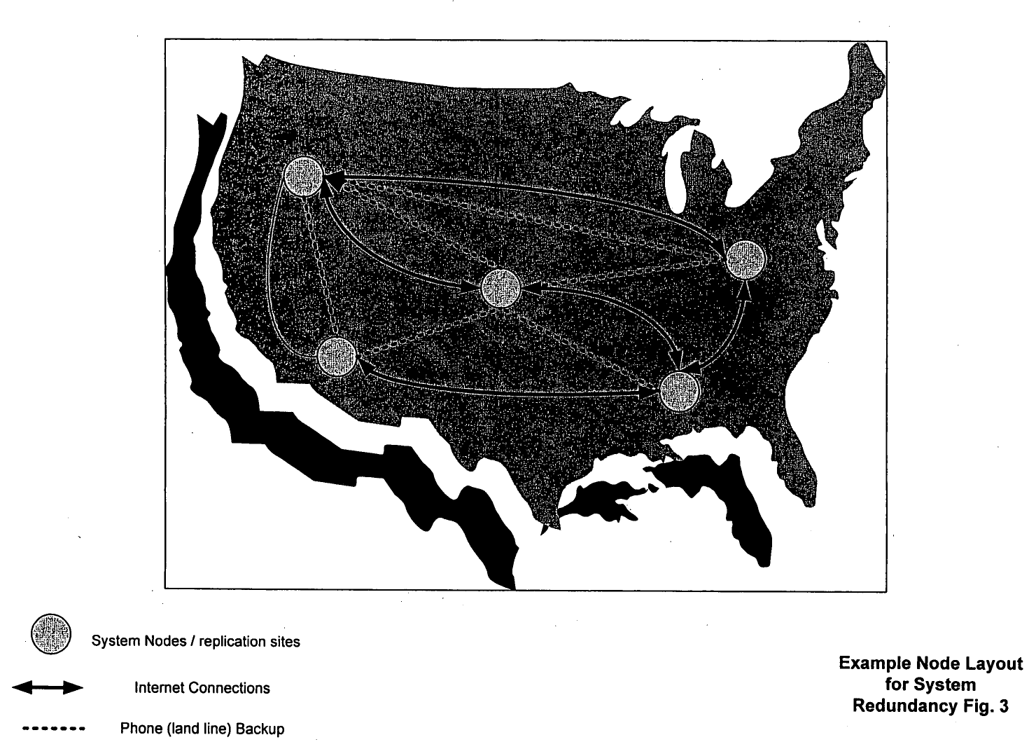

FIG. 4 is a diagram illustrating command and control interface functions of one embodiment of the present invention.

FIG. 5 is a diagram illustrating a typical system hardware and interface layout of one embodiment of the present invention.

FIG. 6 is a flow chart diagram illustrating a system flow path and disaster use of one embodiment of the present invention.

### DETAILED DESCRIPTION OF THE INVENTION

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation. The phrase in one embodiment is used repeatedly. The phrase generally does not refer to the same embodiment, however, it may. The terms comprising, having and including are synonymous, unless the context dictates otherwise.

OVERVIEW

The easiest way to comprehend the extent of the problem and the inventions' solution to it is to understand how healthcare workers are identified and verified during normal times. Let's say a hospital wants to allow a new physician into its facilities. The process for admitting that physician to the hospital medical staff can be broken down into two general areas 1) establishing that the physician has the background and training to practice in the hospital and 2) deciding what procedures the physician will be allowed to perform once his background is confirmed. The industry term for these two areas are credentialing and privileging respectively. For ease of description, the remainder of this document will focus on physicians but similar processes apply to all healthcare workers that are involved in patient care.

A. CREDENTIALING

The normal credentialing process is typically very extensive and comprehensive. An average physician credentialing application can be in excess of 10 pages and at its worse, as in the case of Medicare, 52 pages. Liability issues and publicity surrounding unqualified doctors has driven this background collection and checking to an extreme level. Further, and more importantly, the hospital is not only required to gather the information from the doctor, they are also required to conduct a first hand verification of some of the information provided.

The process of checking background information, in all it forms, is generally referred to in the industry as “Verification.” It is a loose term that can mean anything from checking a single item to checking almost everything in the application. There are some government regulations defining a “minimum” check but most hospitals rely on “best practices” and the guidelines of industry associations when verifying additional items. A typical hospital will verify such things as other hospital affiliations, medical school graduation dates, employment history, state medical licenses and will run queries against the National Practitioner Data Bank (NPDB) and the Office of the Inspector General database (OIG). Much of the information that a hospital needs to verify is not accessible electronically or is available electronically but not under a uniform standard. For example, each state has its own separate, non-standard licensing database which requires the verifier to conduct multiple queries or in some cases, send a letter.

Given the level of information used and time required during the normal credentialing process, any emergency system would have to address the verification process in some automated way. This could be accomplished by establishing an extensive national database of doctors that would be available as a single source. However, there are many obstacles to creating such a database and industry attempts to do so have been ongoing for over 10 years without success. Consequently, a method is needed to verify data quickly and accurately and can best be achieved by 1) reducing the number of verifiable items to a minimally acceptable standard and 2) providing some means to either pre-verify the data or verify the data electronically when needed. Industry regulations consider any data older than 120 days to be unreliable, and hence unusable, which further supports the need for a real time or near real time verification process.

B. PRIVILEGING

Once a physician, or other healthcare worker, has successfully past the credentialing process, the hospital must then decide what the doctor will be allowed to do in their hospital. The list of those allowed items are called “privileges”. Privileges are usually lists of medical procedures that a particular medical department within the hospital has established and consist of a description of the procedure as well as the criteria necessary for a privilege to be assigned to a physician.

Individual physician privilege assignments can be governed by the physicians' training, experience or specialty board certification, as examples. However, the concept of specific requirements defining which privileges a physician gets is relatively new. In many hospitals, privileges are a simple list of all the available procedures that could be supported at a given hospital and the physician simply tells the hospital which ones he wants to perform. This can lead to a situation where under trained or unqualified doctors are performing procedures beyond their professional scope. Fortunately, a more refined list of privileges based on research, education and training is starting to be embraced by the healthcare industry. This new privileging approach is referred to as “core privileging” and new organizations such as the Credentialing and Privileging Consortium have established the first complete set of core privileges.

In an emergency situation that required additional medical personnel be brought to the disaster scene, it would be very helpful to know which privileges a physician had and the qualifications those privileges represented. However, until all hospitals have converted to core privileging, the list a doctor provided would be somewhat meaningless. Conversely, with core privileging, the ability to identify those individual with a very specific skill, their level of training and even proficiency could be established. Therefore, an emergency system should, at the very least, be able to support core privileging data.

C. SUMMARY AND IMPLICATIONS

By now, it should be apparent that credentialing and privileging are at the heart of the healthcare systems normal methodology for ensuring the quality of their personnel resources. Although a disaster support system is far more extensive than just these two items, any solution will need to encompass both items and reflect some consistency with the current processes so as to insure that non-disaster personnel can quickly assimilate the data being made available.

DESIGN CONSIDERATIONS AND CONSTRAINTS

A. OVERVIEW OF GENERAL CONSIDERATIONS

The design of a successful system to coordinate and manage medical personnel in a disaster encompasses three main areas 1) support structures to gather and maintain healthcare worker information before the crisis 2) functions to support the actual deployment and management of healthcare personnel during a crisis, 3) system architecture that supports redundancy, security and access at all times.

B. SUPPORT STRUCTURES

The system support structure should allow for and facilitate the following:

The use of a common data set or standard to support the easy interchange of data between all parties supplying healthcare worker information.

Allow for easy input and maintenance of healthcare provider data. The entry and maintenance of data should support either individual healthcare worker users or mass updates via electronic file transfer from institutions.

Include reporting functions to allow for monitoring of information stored in the system

Provide features such as automatic notification to healthcare providers when important documents or other time sensitive attributes are expiring.

Contain some mechanism to provide for communications to users, administrators and healthcare providers.

C. DEPLOYMENT

The actual use of a system during an emergency or disaster should support or accomplish the following:

Allow for activation of the system and identification of healthcare personnel resources. This could be by type, specialty, geography, training or other requirements.

Provide a means for contacting healthcare personnel by either phone, fax, email, radio or other conveyance. Provide information to the healthcare worker with respect to conditions at the scene, needs, transportation arrangements, hazards or other pertinent information.

Provide a means for a summoned healthcare worker to respond to the request and pass pertinent information like arrival times, special equipment and mode of transportation, for example.

Automatically verify the healthcare workers credentials and/or privileges and provide a means for direct verification by authorized persons if available.

Authenticate the healthcare worker upon their arrival at the disaster scene.

D. SYSTEM ARCHITECTURE

The system architecture should encompass a number of properties.

The system should use the internet, or other common network, as the primary interface.

The system should be usable by connecting to it via the internet, telephone, cellular devices or even radio interconnections to phone systems.

The system should be fully redundant and support distributed processing by having “mirrored” systems located over a wide geographical area to preclude having the system itself destroyed by some disaster or act.

Be secure in the storage, transmission and access to data. Command and control structures should allow for granting access to the system, both normally and during a crisis.

HIGH LEVEL EXAMPLE

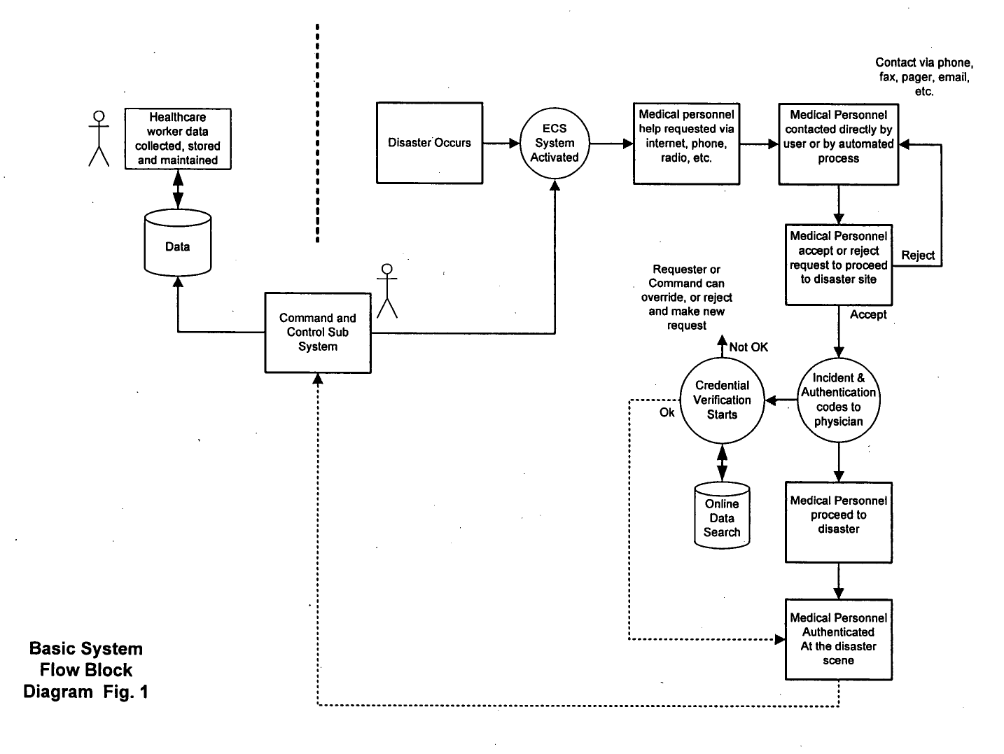

Based on the constraints outline in the three previous areas, a high level example of how they might fit together should aid the reader in understanding the fundamentals of using and deploying such a system. See, for example, FIG. 1.

A. BEFORE THE CRISIS

The first thing needed for the system to be successful is healthcare provider data. Ideally, this could come from a number of sources but the easiest implementation would be to have hospitals supply the lists of doctors and their related information. A hospital could log on to the system and type the data in manually or they could submit some type of easily composed electronic file. A simple spreadsheet would be a good example that would provide an easy means for all hospitals to be able to participate without a large investment in time or money. The data that would be supplied would be physician information as establish in a published standard and would be the minimum necessary to support an emergency deployment.

The command and control organizations would establish a list of emergency management personnel, their roles and their authority level to activate the system or to allow specific users into the system. Activation could also be supported through automatic “triggers” such as multiple requests for ambulances to the same general location, for example.

B. DURING A CRISIS

At the outset of a crisis the system would be “activated” by authorized emergency management personnel. Use of the system could be allowed at many levels, even all the way down to individual rescuers at the scene if needed.

In any case, the first action after activation would be for a responsible party (user) to connect to the system. This could be done via internet, phone, radio or any other supported communications method. The user could then request assistance in any number of ways. For example, he could ask the system for just a number of physicians, physicians by specialty or even physicians by their distance from the disaster scene.

Once the request for help is made, the physicians would be contacted. The system would automatically try to establish contact and would start with the physicians preferred method of contact. The system would proceed to other contact methods if the physician did not respond in some time limit; either pre established or set by the user at the scene. The physician could then respond by logging into the system via the internet, phone or other method. If the physician declined for some reason, the user could select another physician or in the case of an automatic system choice, the system could pick the next physician in the list. If the physician indicates that he is available and willing to assist, then the physician is provided with an incident number and could also be given information about general conditions at the scene, things he should bring with him or even transportation arrangements.

As physicians accept the request for help, the user is notified of the acceptance and could be supplied with additional information such as the providers expected arrival time, supplies being brought or even live GPS information on the physicians' current location.

At the same time, the user is being notified of the physician's acceptance. The system will launch an automated verification process on the physicians' pre-supplied information. This verification would be limited in scope but extensive enough to assure rescue and command personnel that the doctor is in good standing and permitted to assist. The system would alert users of any problems or inconsistencies in the verified data and the user could act appropriately.

When the physician arrives on the scene, he will contact the user or the appropriate command structure and present some form of identification to assure personnel on the scene that he is physician requested.

C. SYSTEM ARCHITECTURE TO SUPPORT A CRISIS

The systems architecture would be internet based and fully redundant. Several sites across the country would be established and all sites would be “mirrored” so as to provide for distributed processing. This would preclude the possibility of destruction of the system which would be possible if only a single site is used.

A very important aspect to the systems' architecture is communication support. Availability of the internet could not be guaranteed in a given disaster so, the system must support other methods of communication and interaction with rescuers. This could be achieved through the use of interactive voice recognition technology. There are a number of methods for connecting data to voice interfaces; VoiceXML is a good example of such a tool that could be deployed without sacrificing security. Once IVR is employed, then the only difficulty for rescue personnel is in connecting to a phone system which is easily supported by cell phone, radio link ups or even satellite connections.

COMPONENT DESCRIPTION AND DESIGN BASIS

A. STANDARDS AND DATA COLLECTION

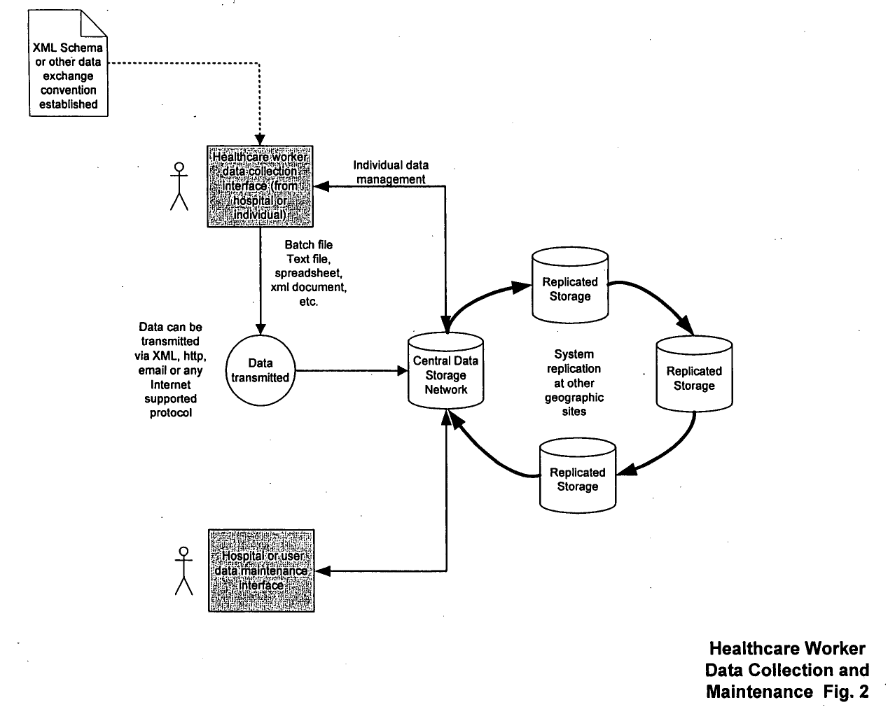

At the core of an effective and easy to manage data collection is the need for some standard with respect to the breath and depth of the information collected from healthcare workers. This could be accomplished through the use of Electronic Data Interchange Standards (EDI) or other file exchange standards. One of the current and most effective methods available for use in this application is to employ an Extensible Markup Language (XML) schema. Publishing a standard schema will enable any number of interfaces or web services to be easily constructed by organizations wishing to interact with the system directly. The ease presented by this standard will also allow for wide spread adoption with little expense or technical expertise. In its easiest form, it is envisioned that a participant could simply email a spreadsheet that observes the schemas' same naming convention. The system could then parse the data from the emailed attachment and update a database. See, for example, FIG. 2.

The choice of elements of data to be included in the system is critical. While more data can always be added, minimizing the breadth of data will allow for quick adoption and more importantly, a simplistic approach to system processing and use. As a minimum, the system should include the following basic healthcare worker data:
Name—Last, first, middle
Social Security Number
Contact Information
   Address—Address line 1, address line 2, city, state, zip code
   Phone no., fax no., pager no., answering service no., other
   Preferred method of contact—(e.g. phone then fax then pager, etc.)
Entity submitting data (e.g. hospital, individual, state etc.)
Date of last re-credentialing or re-appointment (as applicable)
Healthcare provider type (e.g. doctor, nurse, etc.)
Medical Specialty
Professional Degree (or other designation)
Medical License state, number, expiration date

Other data could also be collected that could add to the ease of administration however, keeping the initial list as short as possible will aid in rapid adoption. Some anticipated add on data could be as follows:

Medical Board Certified—Y/N

Training Level—specialized training indicators such as bioterror for example

Core or Special Privileges granted by a specific hospital(s)

DEA certificate information and expiration date

Attachments to the record such as pictures or sound files

B. REPORTING

There are a number of useful reports that can be generated for the collected healthcare worker data and depending on the users “permission” level, these could include profiles and summaries such as directories of healthcare workers by specialty, geographical region, degree, type or any other data element. The system can also be used to monitor expiration dates and automatically contact providers to supply updated information.

C. CREDENTIALING AND VERIFICATION

Once the data is entered, it is replicated to each of the mirrored sites in the network and is immediately available for use. Although the intended design is to verify the health workers' credentials at the time they are called to participate in an emergency, it is not inconceivable that verifications could be done at the time a record is entered or updated in the system. This could shorten processing time during an emergency but, since the verification itself is time limited, it could be rendered meaningless by the time it is requested during a disaster.

Given the above, the optimal time for conducting a verification of the healthcare workers' data is when the system is in use as a result of a disaster. Therefore, since on scene personnel have neither the resources, nor perhaps the training, to conduct a verification, the system will need to conduct one automatically.

Currently, the industry is not in complete agreement as to the exact items that need to be verified but there are a few items that will be included in any future standard. Nothing in the system design would preclude adding or removing items to be verified. The items most likely needed for a simple verification will be: verification of any medical licenses, a search of the National Practitioner Data Bank (NPDB) and search of the Office of the Inspector General (OIG) Data Bank. The NPDB and the OIG both maintain directly searchable databases however, most states have only a web page interface in which a user can enter the worker information and then wait for a response. Other items that might be added to the verification process, like criminal background checks, are often a composite of several searches which complicates the process.

In order to conduct these searches in real time, the system will have to employ some method of 1) getting to the appropriate database or web site and 2) if the database will not support a direct query, some tool to capture the data from the web page. This can be accomplished by combining two known software tools, a “web crawler” and browser based “screen scraper” each being modified for the purpose.

A web crawler is a software tool that can locate a particular web site or database and a screen scraper is a tool to extract the content from a web page. The system would use these tools such that the web crawler could be instructed to find the appropriate web page, populate the form on that page and submit that page back to web server. Once the data is returned from the submitted page, the screen scraper will capture the returned page and then extract the data contained in that page. In this fashion, the systems could “visit” state license web sites, submit the healthcare workers' data and then capture the response. Post capture filters could then parse and process the document to determine if a license had expired for example.

D. COMMAND AND CONTROL

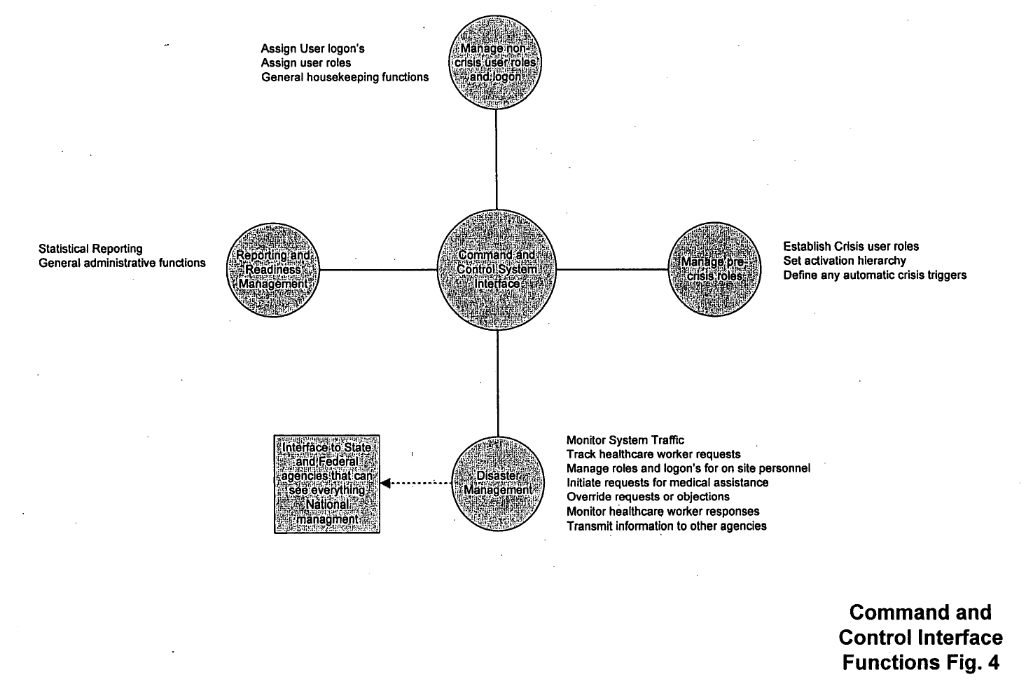

It is anticipated that there will be several levels of command and control that could extend from the on-site rescuer to high levels of the federal government. See, for example, FIG. 4. It is difficult to foresee all the possible deployments of the system but as a minimum, the following user types and accesses are necessary for the system to function according to design and “best guess” implementation. Normal, non-crisis application access is not considered here as it differs little from other large organization role and user management. It is also anticipated that geographical control to some extent will be needed and will be included as part of the various user roles.

SUGGESTED ROLES

End user or Rescuer on scene has the ability to access and use the system in “crisis” mode when permitted by an Area or Scene Commander.

Area Command—The person responsible for coordinating a group(s) of rescuers. This person will be able to access the system with some “local” geographical restrictions. This person will be able to allow rescue personnel “crisis” access to the system. The purpose of being able to assign access to lower levels is to minimize relay time in an emergency. The area commander will be able to monitor all the traffic generated by his assigned rescuers.

Regional Command—A person responsible for the coordination of disaster efforts of one or more areas. This user has all the access rights of the Area commander but is less geographically restricted and can monitor the requests of Area Commanders and their subordinates.

State Commander—Similar to a regional commander, this user has responsibility primarily for one state and is geographically restricted to operations in a given state.

Federal Commander—FEMA personnel have access to all regions and states and can monitor all aspects of the systems use.

In any case, the system is designed to accept many levels of users depending on the political and geographic restriction agreed upon by the entities involved.

E. SYSTEM ARCHITECTURE

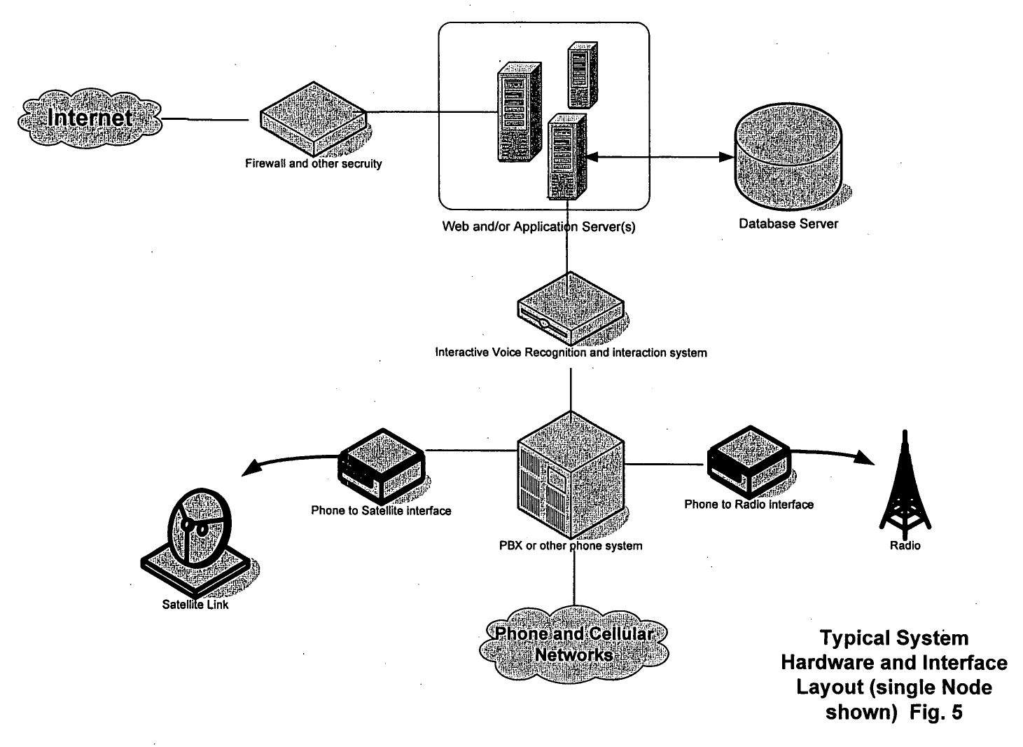

For a system architecture discussion, a single system is composed of a web server, an application server, a relational database, an Interactive Voice Recognition (IVR) component and several support interfaces to outside communications systems See, for example, FIG. 5. The components can reside together on a single server or multiple servers connected to each other via a network. External connections are to the internet, telephone networks, emergency radio networks and satellite uplink. The telephone connection supports the IVR as well as system generated phone calls, faxes, etc. to users and healthcare personnel.

Above the component level, the main system architecture aspects are redundancy, accessibility and security.

REDUNDANCY—Since the systems primary use is to support a disaster or emergency, the system is deployed with high availability and redundancy. The system can support any architecture that meets that requirement and supports some form of data replication and distributed processing. Locating several “clones” of the system around the country insures that as long as at least one site is undamaged, the entire system would still function.

ACCESSIBILITY—The systems' principal forms of communication are the

Internet, the general telephone network, cellular networks, emergency worker radio networks and satellite connections to any of the former. The system could use any type of network or communications systems that supported standard protocols. For simplicity, we will limit further discussion to the internet and the public telephone system.

The systems general and administrative functions such as data upload and maintenance are via an internet connection to or through a web server to a web application server(s). The entire system, both the administrative as well as the disaster management portions, can be used at a disaster site via the internet if it is available

If the internet is not available, relief personnel can contact and use the system via an interactive voice recognition (IVR) interface. A user would call a phone number that would connect to the IVR and though the use of either the keypad or voice commands, could interact with the system and request healthcare personnel assistance with the same net result as had it been done via the web interface. If user communications are intermittent because of telecommunications or operational problems, the IVR system will recall where the user was before the interruption and continue the process or supply update reports.

A possible option for system access and activation could be through the establishment of “blanket codes” that performed some complex function but could be initiated through a single key word, code or short sequence. This would be particularly useful for disasters that could be described by a general category for example, a code labeled as “plane crash” could summon a predetermined group of healthcare workers or a key word of “bioterror” could summon those healthcare workers specifically trained in bioterrorism.

SECURITY—Because of the potential importance of this system, special attention to security is a must. At the hardware, application and network level, there are already information technology industry “best practices” for the design and implementation of security such as firewalls and intrusion detection for example. Additionally, communications could be made via secure transmission protocols such as Secure Socket Layer (SSL) and phone communications could be conducted via closed circuits, monitored lines or military type “scrambling” technology.

Operationally, security is split between non-disaster and disaster conditions. In non-disaster use, security for the application is role based, hierarchical and not too different from application security in any large organization. Users and their roles would be established primarily by management consensus and follow traditional paths. Support for personal identification numbers (PIN), biometric identification, independent security confirmation systems and other forms of user related security would be included

Actual disaster security requires some special handling. In addition to the traditional user security roles and controls mentioned earlier, special consideration needs to be paid to authentication of healthcare workers arriving on the scene of a disaster. In other words, is the healthcare worker that was requested actually the person who has appeared at the scene? Reliance on any form of identification that is not dynamic in nature could be risky. Traditional facility based identification such as badges, can all be stolen or counterfeited. The best solution is to issue some sort of dynamically created disaster identification number along with a dynamically generated security code that could be verified at the scene.

In actual use, the system could create a disaster or incident identifier at the time of system activation by authorized command personnel. This general number could be encrypted and included as part of any subsequent system transactions. Both the healthcare workers as well as command personnel would use this number. However, there is an added need to insure that an individual healthcare worker is uniquely identifiable. Therefore, the system would also dynamically generate a coded number for each individual healthcare worker at the time the worker accepted the request for his/her assistance. This number would be required, along with the incident code, for a healthcare worker to be admitted to the scene of the disaster. Possibly, the only requirement beyond the coded identifiers would be some sort of picture ID. Healthcare workers that responded to a request via the internet could also print a bar code representation of the code(s) which would reinforce the process. Airlines have used similar methods of identification and access for passengers and crew. As an option, at the time of registration the healthcare worker could be issued a small tag that could be placed on a key ring that contained some additional coded identifier such as an encrypted number. This number would be known only to command personnel and could be used as an added discriminator when any question arose as to workers authenticity.

Also along security lines, the system should support a full audit trail by using basic audit strategies that has been established in the software and accounting industries for some time. Additionally, audit trail support could be constructed as to specifically support post disaster analysis.

SYSTEM FLOW PATH AND USE

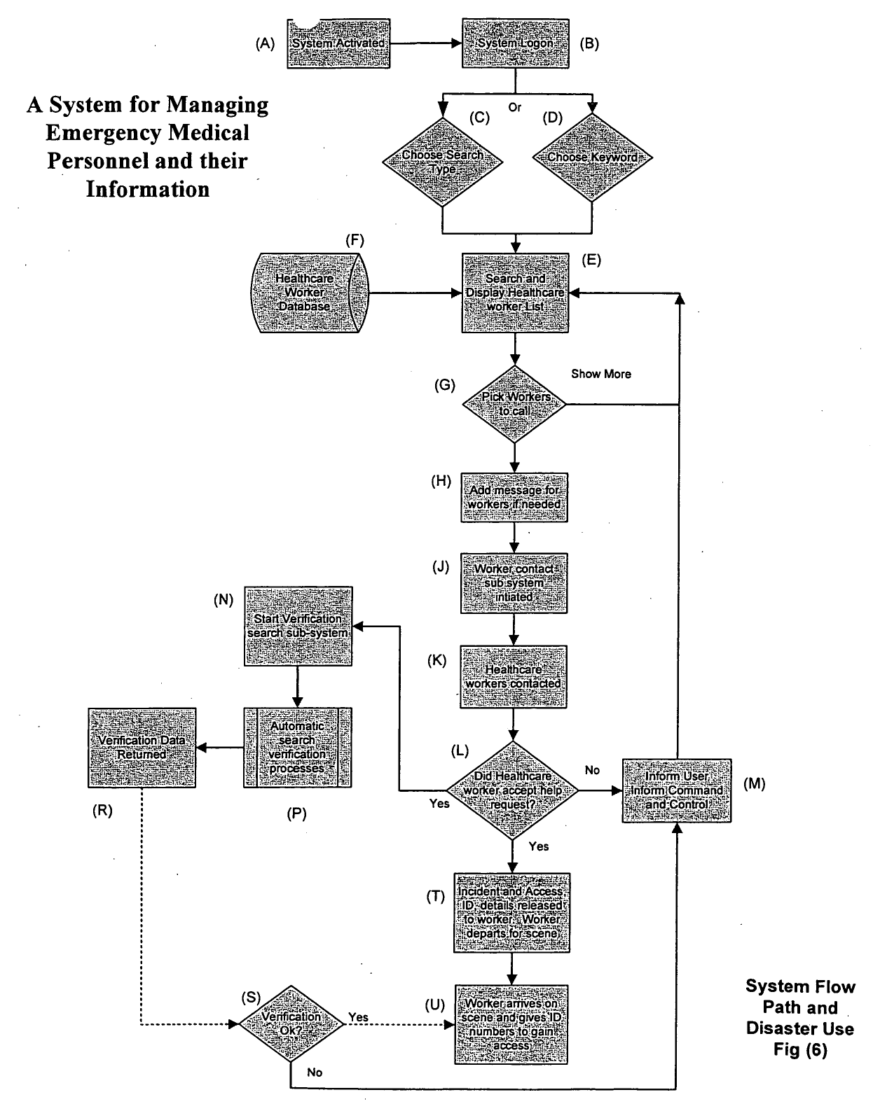

Please refer, for example, to FIG. 6. Since the use of the system is primarily to support a disaster, the following description of the system use and flow paths will be limited to its use during an emergency deployment. The discussion is further limited to using the system via the internet however; references to the Interactive Voice interface will be mentioned when appropriate. IVR access to the system would observe the same overall flow as the internet deployment and should differ only by presentation and abbreviation of lists and like items.

The initial action taken with the system is to “activate” it (A). This is done by a request from virtually anyone connected with a disaster. However, actual activation will be by a previously defined command and control user(s) in accordance with a management protocol. It is anticipated that some automatic escalation features will be included that would allow the system to eventually find an authorized person from a list of command personnel. The system would also generate the Incident ID at the time of activation.

The system would then require a user to log on to the system (B) to begin the process of choosing and contacting healthcare workers needed for the disaster.

The first action of the user is to conduct a search for list healthcare workers that are needed (C). This search could be conducted by specialty, training, zip code radius, geographical location, procedure type, experience or any other data available.

The search (C) will return a list of healthcare workers (E) from the database of healthcare workers (F). This list should be presented in a name blinded format and would give only pertinent information organized and presented in the same nature as the search. For example, if a geographic type search was conducted, the resulting list could be displayed on a map that could be manipulated as needed. If a specialty search was conducted, a list of specialties, or specialties close to the request, could be displayed by distance from the site or experience of the personnel.

A search (D) could also be conducted by predefined disaster types such as “plane crash” or “bioterror” by entering a single keyword or phrase. This would the “jump” the system ahead and begin contacting healthcare workers in accordance with the plan (J and beyond). This would be a very useful feature for the IVR system since even a brief exchange of information at the scene may be burdensome.

The search and display processes would be iterative (G) until all the needed healthcare workers were chosen. At this point, the user would be able to attach instructions regarding conditions at the scene, equipment needed or transportation arrangements. If the IVR system is in use, this could be a recorded message.

The list of chosen healthcare workers would then activate the healthcare worker contact sub-system (J). The purposes of this sub-system are to contact, alert and inform the chosen healthcare workers of the disaster. This is accomplished by contacting all the contact sources previously supplied by the healthcare worker such a phone number, fax, cell phone, pager, etc. The IVR could conduct the phone and cellular communications and “read” the information to the healthcare worker.

Once the healthcare worker has been contacted (K), he/she has the ability to accept or reject the request for help (L). This is done by having the worker contact the system via any of the methods supported. The healthcare worker would enter their unique log on Id, the supplied Incident ID and their yes/no type response.

If the worker rejects the request (M), the requesting user and command and control personnel are informed of the decision. The user, or command and control, can then choose another provider by returning to the search results (E).

If the worker accepts the request (L), then two events are triggered 1) the system begins the Automatic Verification process (N) and 2) the system generates an unique Access ID number and give the worker the Incident ID, the Access ID and delivers any messages that were attached to the incident (T). The worker is then free to proceed to the disaster site in accordance with procedure.

The verification subsystem activation will cause the system to access the healthcare workers data (F) and begin the verification process using the Automatic Search engine (P). The results of the search are then processed (R) against know rules and the system determines if the resulting data indicates whether the worker is in good standing. If the search is unable to collect the information needed or the information is contrary to what is expected, then the system will inform the requesting user, command and control (M) and the worker if possible. Command and control will then return to the system and search (E) for another worker to fill the void. If the worker can be contacted while in route, the worker can then be instructed not to proceed further or be allowed to proceed to the scene with the understanding that there role may be restricted or not used. The choice of using these workers will be at the discretion of command and control.

Once the cleared healthcare worker arrives on the scene, he contacts the person in charge. The worker then gives the Incident ID and the Access ID to the person in charge who can then verify it with command and control or other authorized personnel (U). This ends the general process.

While the present invention has been related in terms of the foregoing embodiments, those skilled in the art will recognize that the invention is not limited to the embodiments depicted. The present invention can be practiced with modification and alteration within the spirit and scope of the appended claims. Thus, the description is to be regarded as illustrative instead of restrictive on the present invention.

What is claimed is:

1. A system to request, coordinate, credential and manage medical personnel and their information to support disasters or emergencies, the system comprising:
a system to manage medical personnel credentialing information;
a system to automatically contact medical personnel;
a system to provide a means for automatically verifying medical personnel credentialing and privileging information; and
a system to provide a means for the authentication of medical personnel.

2. The system of claim 1, wherein the system to manage medical personnel credentialing information uses standard interchange formats or sub-sets of standard interchange formats.

3. The system of claim 1, wherein the system to manage medical personnel credentialing information allows for mass updates using simple text files, spreadsheets or XML documents with or without the use of web services.

4. The system of claim 1, wherein the system to manage medical personnel information exchanges data between individuals, hospitals and local, state and federal agencies using a common EDI or XML standard or a subset of those standards.

5. The system of claim 1, wherein the system to manage medical personnel information can be searched by user type, geographic location, medical specialty, training or other discriminator.

6. The system of claim 1, wherein the system to manage medical personnel information recognizes users by Personal Identification Numbers, biometric identification, face recognition or through the use of external security processing mechanisms.

7. The system of claim 1, wherein the system to automatically contact medical personnel utilizes phone, cellular phone, fax, email, internet or other messaging formats.

8. The system of claim 1, the system further comprising a system to provide a means for requested medical assistance personnel to respond to the request in either a positive or a negative fashion.

9. The system of claim 1, the system further comprising a system to provide a means for informing users and system managers of medical personnel response to requests.

10. The system of claim 1, wherein the system to provide a means for automatically verifying medical personnel credentialing and privileging information communicates utilizes an internet search interface and or capture interface.

11. The system of claim 1, wherein the system to provide a means for the authentication of medical personnel comprises generation of unique alpha, numeric or alphanumeric codes.

12. The system of claim 1, the system further comprising a system to provide medical personnel information during a disaster via secure communications network using encryption or scrambling technology.

13. The system of claim 1, the system further comprising a system to provide a means for the storage, processing, management and dissemination of medical personnel information.

14. The system of claim 13, wherein the means for the storage, processing, management and dissemination of medical personnel information is fully redundant in case of disaster; supports many levels and types of users; supports a separate command and control structure.

15. The system of claim 13, wherein the means for the storage, processing, management and dissemination of medical personnel information is activated via single words or short phrases.

16. The system of claim 13, wherein the means for the storage, processing, management and dissemination of medical personnel information is used by on scene rescue personnel and is accessed via the internet or through other communications channels through the use of interactive voice recognition systems.

17. The system of claim 1, the system further comprising a system to provide for the tracking of medical personnel through the use of the Global Positioning System capability in cell phones and other portable devices.

18. The system of claim 1, the system further comprising a system for the graphical or numerical display of summoned emergency medical personnel using Global Positioning System information.

19. A method to request, coordinate, credential and manage medical personnel and their information to support disasters or emergencies, the method comprising:
managing medical personnel credentialing information;
automatically contacting medical personnel;
automatically verifying medical personnel credentialing and privileging information; and
authenticating medical personnel.

20. A system for support in disasters or emergencies, the system comprising:
means for requesting medical personnel and their information;
means for coordinating medical personnel and their information;
means for credentialing medical personnel and their information; and
means for managing medical personnel and their information.
